(19) United States
(12) Patent Application Publication
(10) Pub. No.: US 2026/0227276 A1
(43) Pub. Date: Aug. 6, 2026

(54) DEEP-SEA ENVIRONMENT SIMULATION TEST EQUIPMENT AND CONTROL METHOD THEREOF

(71) Applicant: Hunan University of Science and Technology, Xiangtan (CN)

(72) Inventors: Yongping Jin, Qiandongnan Prefecture (CN); Shuli Liu, Luohe (CN); Buyan Wan, Changsha (CN)

(21) Appl. No.: 19/632,003

(22) Filed: Mar. 27, 2026

(30) Foreign Application Priority Data
Dec. 3, 2025 (CN) 202511807997.6

(51) Int. Cl. G01M 10/00

(52) U.S. Cl. CPC G01M 10/00

(57) ABSTRACT

Provided are a deep-sea environment simulation test equipment and a control method thereof, the deep-sea environment simulation test equipment includes a high-pressure simulation chamber and a measurement and control device. The high-pressure simulation chamber includes a high-pressure pump station and a high-pressure chamber body, the high-pressure chamber body is provided with a simulation device, the simulation device includes a motion simulation component and a crack simulation component, and the measurement and control device includes a control component and an acquisition component. The control component includes an industrial computer, a water flow simulation control module, and a crack simulation control module. The present disclosure achieves the simulation of dynamic water flow effects and structural crack defects in deep-sea environments by providing a simulation device including the motion simulation component and the crack simulation component in the high-pressure simulation chamber body.

### CROSS-REFERENCE TO RELATED APPLICATIONS

Th This application claims priority to Chinese Patent Application No. 202511807997.6, filed on December 03, 2025, which is hereby incorporated by reference in its entirety.

### TECHNICAL FIELD

The present disclosure relates to the field of deep-sea environment simulation test equipment technologies, and in particular, to deep-sea environment simulation test equipment and a control method thereof.

### BACKGROUND

To reduce the risk and cost of failed sea trials and ensure reliable operation of equipment in actual deep-sea environments, almost all equipment used in deep-sea environments, such as sensors, submersibles, resource exploration devices, etc., must first undergo pressure and sealing tests in simulation chambers.

However, existing deep-sea environment simulation chambers generally only provide static pressure testing and lack corresponding experimental equipment for dynamic motion simulation in deep-sea environments, such as water flow simulation in deep-sea environments. This is because the motion inside a closed pressure vessel may cause severe fluctuations in the pressure inside the high-pressure chamber, thus affecting the stability of the pressure inside the high-pressure chamber and even endangering the safety of the experiment.

Therefore, it is urgent to improve the technology of existing deep-sea environment simulation test equipment, enhance its dynamic simulation capability, to more realistically reproduce the complex deep-sea environment, and comprehensively improve the effectiveness of the test and the reliability verification level of the equipment.

In response to the technical problem mentioned above that existing deep-sea environment simulation test equipment generally only provides static pressure testing, and the movement inside a closed pressure vessel may cause severe fluctuations in the pressure inside the high-pressure chamber, affecting the stability of the pressure inside the high-pressure chamber, the technical solution adopted by the present disclosure to solve the technical problem is as follows.

A deep-sea environment simulation test equipment, including: a high-pressure simulation chamber and a measurement and control device, where the high-pressure simulation chamber includes a high-pressure pump station and a high-pressure chamber body configured to simulate deep-sea high-pressure environment, the high-pressure chamber body is provided with a simulation device, the simulation device includes a motion simulation component and a crack simulation component, where the motion simulation component is configured to generate controllable water flow by rotation, the crack simulation component is configured to generate prefabricated cracks of different sizes, and the measurement and control device includes a control component and an acquisition component, the control component includes an industrial computer and a water flow simulation control module electrically connected to the motion simulation component, a crack simulation control module electrically connected to the crack simulation component, and the acquisition component is configured to record parameters inside the high-pressure chamber body and state parameters of a to-be-test object.

In an embodiment of the present disclosure, the motion simulation component includes a bracket, an outer fixing cylinder connected to the bracket, an inner rotating cylinder provided inside the outer fixing cylinder, a rotating component connected to the inner rotating cylinder, a gap provided between an inner wall of the outer fixing cylinder and an outer wall of the inner rotating cylinder, the outer fixing cylinder is provided with the outer fixing cylinder inner cavity, an outer wall of the outer fixing cylinder is provided with a first installation hole communicated to the outer fixing cylinder inner cavity, and an arc-shaped base plate connected to the first installation hole; an inner wall of the arc-shaped base plate is connected to a motion simulation test object.

In an embodiment of the present disclosure, the bracket includes a bracket top plate, a bracket middle plate, a bracket bottom plate, a first bracket column connected between the bracket top plate and the bracket middle plate, a second bracket column connected between the bracket middle plate and the bracket bottom plate, the outer fixing cylinder is provided between the bracket top plate and the bracket middle plate, the rotating component includes a driving part provided on the bracket bottom plate, a driving shaft connected to the driving part, and a main shaft component that is connected to the driving shaft and the inner rotating cylinder.

In an embodiment of the present disclosure, the outer wall of the outer fixing cylinder is fixed to the first bracket column, and the main shaft component includes a main shaft, a coupling connected to the driving shaft and the main shaft, a first bearing provided on the bracket top plate and connected to the main shaft, and a second bearing provided on the bracket middle plate and connected to the main shaft, where the main shaft passes through the bracket middle plate, the outer fixing cylinder, the inner rotating cylinder, and the bracket top plate.

In an embodiment of the present disclosure, the crack simulation component includes a push rod component fixed to the bracket middle plate, a connection rod connected to the push rod component, and a clamping component connected to the connection rod, the outer wall of the outer fixing cylinder is provided with a second installation hole communicated to the outer fixing cylinder inner cavity, and the clamping component is embedded into the second installation hole.

In an embodiment of the present disclosure, the push rod component includes a linear travel motor, push rods respectively connected to the linear travel motor and the connection rod, a watertight shell connected to an outer side of the linear travel motor, the connection rod is provided with a fixed part that cooperates with the outer fixing cylinder, the connection rod is fixed to the outer wall of the outer fixing cylinder, and the clamping component includes a base plate connected to an inner side of the second installation hole, a fixing clamp provided on the base plate, and a movable clamp that is connected to the connection rod and is configured to move relative to fixing clamp; where a crack simulation test object is connected between the movable clamp and the fixing clamp.

In an embodiment of the present disclosure, a lower end of the connection rod is connected to the push rods, a middle of the connection rod is connected to the outer wall of the outer fixing cylinder through a fixed part, and an upper end of the connection rod is connected to the movable clamp; in an initial position, the movable clamp is in contact with the fixing clamp, when the linear travel motor runs, a movement direction of the upper end of the connection rod is opposite to that of the push rods.

In an embodiment of the present disclosure, the motion simulation component includes a compensator provided on the bracket bottom plate, the high-pressure chamber body is provided with a high-pressure chamber for the simulation device to extend into, and an end cover covering an opening of the high-pressure chamber, where the measurement and control device is connected to a data port of the end cover.

In an embodiment of the present disclosure, the acquisition component includes a clock synchronization module, a multi-channel signal conditioning module, and an acquisition module, the clock synchronization module is configured to convert a single clock signal into multiple synchronized clocks, the multi-channel signal conditioning module is used for preprocessing data of each channel, and the acquisition module is configured to collect pressure environment parameters and temperature environment parameters of the high-pressure chamber body, water flow velocity parameters of the motion simulation component, crack size parameters of the crack simulation component, and state parameters of the to-be-test object.

In an embodiment of the present disclosure, another objective of the present disclosure is to provide a control method for deep-sea environment simulation test equipment, where it includes the deep-sea environment simulation test equipment, the motion simulation test object, and a crack simulation test object, and the control method includes the following steps:

S1: installing the motion simulation test object and crack simulation test object onto the motion simulation component and crack simulation component, respectively;

S2: after sealing the simulation device in the high-pressure chamber body, connecting the measurement and control device to the high-pressure chamber body;

S3: starting the high-pressure pump station, increasing pressure inside the high-pressure chamber body to a required simulated test water pressure; performing pressurization and depressurization processes in stages, and conducting simulation tests at different pressure levels to observe and recording state parameters of the to-be-test object at different pressures, pressurization processes, and depressurization processes through the acquisition component.

The beneficial effects of the present disclosure are as follows.
1. The present disclosure achieves the simulation of dynamic water flow effects and structural crack defects in deep-sea environments by installing a simulation device including the motion simulation component and the crack simulation component in the high-pressure simulation chamber, effectively overcoming the technical limitations of existing deep-sea environment simulation test equipment that can only perform static pressure testing and cannot simulate dynamic environments and complex working conditions. The present disclosure collects real-time parameters of the high-pressure chamber and the state parameters of the test object through the measurement and control device, combined with the control module to ensure stable pressure inside the high-pressure chamber, avoid severe pressure fluctuations caused by motion simulation, and improve test safety and data reliability.
2. The present disclosure has a simple structure and reliable function. The designed motion simulation component generates controllable water flow by adjusting the motor speed, and restricts the water flow between the outer fixing cylinder and the inner rotating cylinder, which can reduce the impact of water flow on the pressure inside the high-pressure chamber.
3. The simulation device designed by the present disclosure can not only control the crack simulation component to generate controllable sized cracks under static high pressure, but also simulate cracks under dynamically adjustable water flow, combining dynamic and static crack simulation testing functions.
4. The multi parameter measurement and control device designed by the present disclosure can avoid signal distortion and data errors caused by asynchrony.

### BRIEF DESCRIPTION OF DRAWINGS

FIG. 1 is a schematic diagram of a deep-sea environment simulation test equipment according to the present disclosure.

FIG. 2 is a schematic diagram of a simulation device of the present disclosure.

FIG. 3 is a side view of the simulation device of the present disclosure.

FIG. 4 is a top view of the simulation device of the present disclosure.

FIG. 5 is a A-A cross-sectional view of FIG. 4.

FIG. 6 is a schematic diagram of a crack simulation component of the present disclosure.

### DESCRIPTION OF EMBODIMENTS

Below, the embodiments of the present disclosure will be described in detail with reference to the accompanying drawings.

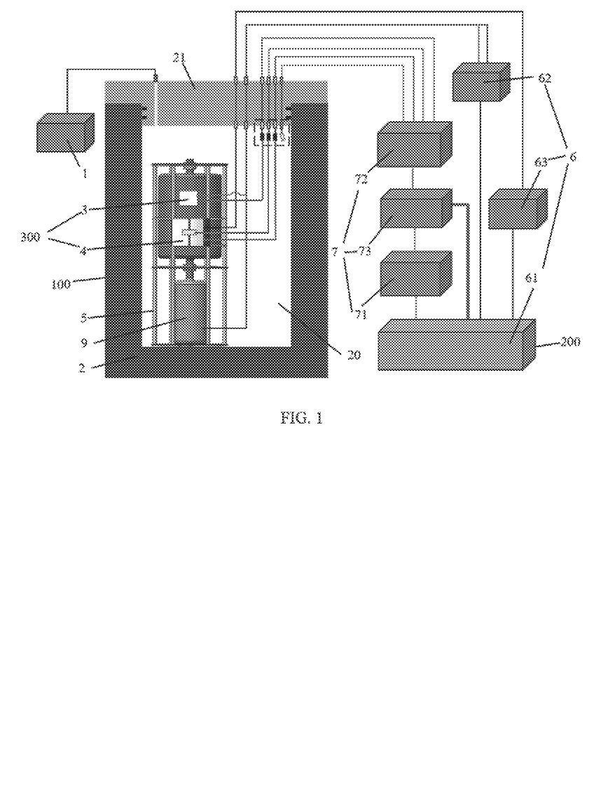

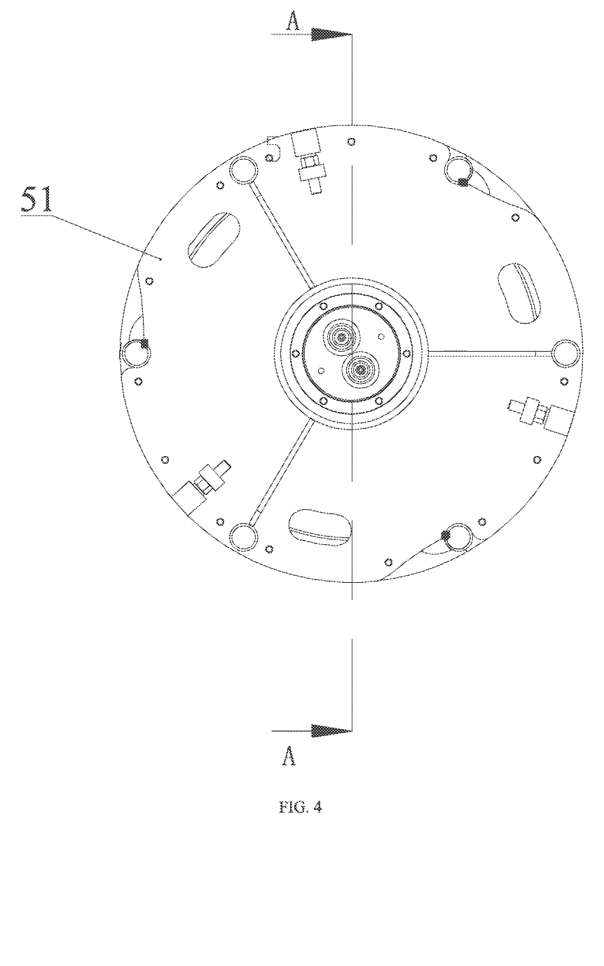

A deep-sea environment simulation test equipment as shown in FIGS. 1 to 6, including a high-pressure simulation chamber 100 and a measurement and control device 200. The high-pressure simulation chamber includes a high-pressure pump station 1 and a high-pressure chamber body 2 configured to simulate deep-sea high-pressure environments. The high-pressure chamber body 2 is provided with a simulation device 300, and the simulation device 300 includes a motion simulation component 3 and a crack simulation component 4. The motion simulation component 3 is configured to generate controllable water flow through rotation, and the crack simulation component 4 is configured to generate prefabricated cracks of different sizes. The measurement and control device 200 includes a control component 6 and an acquisition component 7. The control component 6 includes an industrial computer 61, a water flow simulation control module 62 electrically connected to the motion simulation component 3, a crack simulation control module 63 electrically connected to the crack simulation component 4, and the acquisition component 7 is configured to record parameters inside high-pressure chamber body 2 and state parameters of a to-be-test object.

The present disclosure achieves the simulation of dynamic water flow effects and structural crack defects in deep-sea environments by providing the simulation device including the motion simulation component and the crack simulation component in the high-pressure simulation chamber, effectively overcoming the technical limitations of existing deep-sea environment simulation test equipment that can only perform static pressure testing and cannot simulate dynamic environments and complex working conditions. The present disclosure collects real-time parameters of the high-pressure chamber and the state parameters of the test object through the measurement and control device, combined with the control module to ensure stable pressure inside the high-pressure chamber, avoid severe pressure fluctuations caused by motion simulation, and improve test safety and data reliability.

In an implementation mode, the water flow simulation control module is configured to accurately adjust and set the water flow velocity generated by the motion simulation component, the crack simulation control module controls the crack simulation component to generate controllable sized cracks, and the multi parameter acquisition component is configured to synchronously record high-pressure environmental parameters, motion parameters, crack parameters, and state parameters of the to-be-test object. The industrial computer is electrically connected to the water flow simulation control module, crack simulation control module, and acquisition component. An operator can obtain real-time data and apply commands through industrial control computers, thereby achieving real-time data processing and precise control.

In an implementation mode, the high-pressure chamber is injected with water flow and connected to the simulation device. The motion simulation component of the present disclosure can generate controllable water flow, which can simulate the impact and effect of water flow on the to-be-test object in the deep sea in a closed high-pressure chamber, thereby more realistically reproducing the dynamic stress state of the equipment in the actual deep-sea environment. In an implementation mode, the crack simulation component can introduce prefabricated cracks of different sizes to simulate structural defects that may occur in equipment or materials during use, which helps to study the propagation behavior of cracks in high-pressure environments and their impact on equipment safety. At the same time, the present disclosure realizes the control of various simulation components through the control component in the measurement and control device, and real-time monitoring and recording of the environmental parameters inside the high-pressure chamber and the state parameters of the to-be-test object through the acquisition component, rendering the test process more controllable, repeatable, and data traceable, improving the reliability verification ability and test effectiveness of deep-sea equipment in complex dynamic environments and potential structural defect conditions, effectively overcoming the shortcomings of existing technologies that can only perform static pressure testing and cannot simulate deep-sea dynamic environments.

The present disclosure not only enhances the dynamic simulation capability and environmental adaptability of the deep-sea environment simulation test equipment, but also improves the safety and accuracy of the test, which can promote research and development, testing, and safety evaluation of deep-sea equipment.

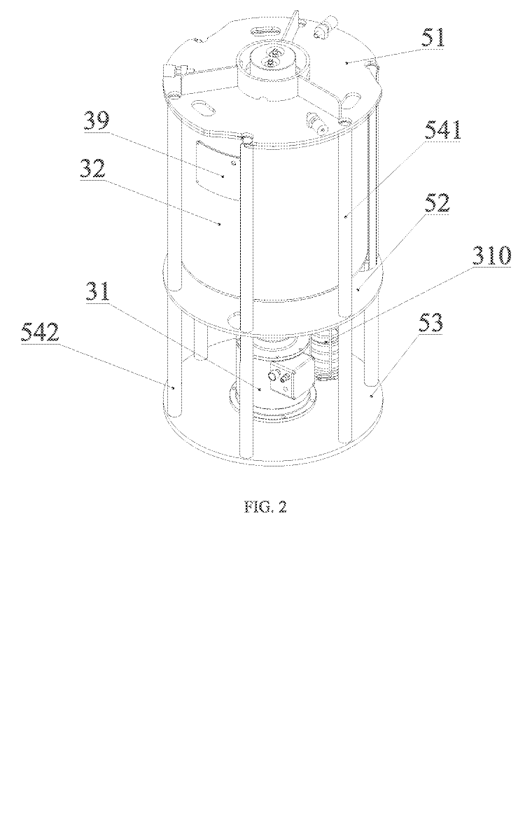

In an implementation mode, the deep-sea environment simulation test equipment as shown in FIGS. 2 to 5, the motion simulation component 3 includes a bracket 5, an outer fixing cylinder 32 connected to the bracket 5, an inner rotating cylinder 33 provided inside the outer fixing cylinder 32, a rotating component 30 connected to the inner rotating cylinder 33, a gap 8 provided between an inner wall of the outer fixing cylinder 32 and an outer wall of the inner rotating cylinder 33, the outer fixing cylinder 32 is provided with an outer fixing cylinder inner cavity 320, an outer wall of the outer fixing cylinder 32 is provided with a first installation hole 321 communicated to the outer fixing cylinder inner cavity 320, and an arc-shaped base plate 39 connected to the first installation hole 321. An inner wall of the arc-shaped base plate 39 is connected to a motion simulation test object 91.

In an implementation mode, the high-pressure chamber is injected with water flow and connected to the outer fixing cylinder inner cavity. The present disclosure uses the motion simulation component composed of the outer fixing cylinder, the inner rotating cylinder, and the rotating component to form a controllable flow channel by utilizing the annular gap between the outer fixing cylinder and the inner rotating cylinder, and driving the inner rotating cylinder to rotate by the rotating component. This stable and adjustable circumferential water flow is generated between the outer fixing cylinder and the inner rotating cylinder, thereby avoiding water flow disturbance and causing severe pressure fluctuations inside the high-pressure chamber, ensuring the stability and safety of the test pressure, and effectively simulating the dynamic flow field in deep-sea environments.

In an implementation mode, the outer fixing cylinder is arranged in a cylindrical shape, and the arc-shaped base plate is adapted to an installation structure of the outer fixing cylinder, which can stably assemble the motion simulation test object. In an implementation mode, when high-pressure fluid flows in the gap, a stable and adjustable velocity circulation or shear flow field can be generated, which can then apply controllable water flow force to the motion simulation test object connected to the inner wall of the arc-shaped base plate, achieving simulation of dynamic water flow impact, shear force or circulation environment in deep-sea environment. At the same time, the structure provides the motion simulation test object on the inner wall of the arc-shaped base plate, it is placed in a near wall area of the flow channel, which can more realistically simulate the local flow field effects experienced by the test object when it is close to the seabed or structural wall in the deep sea, improving the pertinence and realism of the simulation.

Besides that, by adjusting the speed of the rotating component, the fluid flow velocity in the gap between the inner rotating cylinder and the outer fixing cylinder can be flexibly controlled, thereby achieving the regulation of water flow velocity and flow state, and meeting the diverse simulation needs of dynamic water flow environment under different experimental conditions. The motion simulation component of the present disclosure has a compact structural layout and is integrated into the high-pressure chamber, without the need to occupy additional external space. It simplifies the overall structure of the equipment, facilitates collaborative work with high-pressure simulation and measurement systems, and improves the degree of equipment integration.

In an implementation mode, the arc-shaped base plate covers and is sealed on the first installation hole to reduce the water flow in the gap close to the first installation hole to transfer to an outside of the outer fixing cylinder, which affects the water flow impact effect around the motion simulation test object.

In an implementation mode, a sealing component such as a silicone ring, a rubber ring, etc. is connected between the arc-shape base plate and the first installation hole.

In an implementation mode, the arc-shaped base plate is covered in the first installation hole, and the arc-shaped base plate is provided with a connection hole, the connection hole is configured for the water flow simulation control module, acquisition component, and motion simulation test object to be electrically connected.

In an implementation mode, the motion simulation test object can be one or a combination of a sensor, a submersible, a resource exploration device, or to-be-test material.

In an implementation mode, the motion simulation test object is a sensor.

In an implementation mode, the motion simulation test object is a combination of the sensor and the to-be-test material.

In an implementation mode, the deep-sea environment simulation test equipment as shown in FIGS. 2 to 5, the bracket 5 includes a bracket top plate 51, a bracket middle plate 52, a bracket bottom plate 53, a first bracket column 541 connected between the bracket top plate 51 and the bracket middle plate 52, a second bracket column 542 connected between the bracket middle plate 52 and the bracket bottom plate 53. The outer fixing cylinder 32 is provided between the bracket top plate 51 and the bracket middle plate 52, and the rotating component 30 includes a driving part 31 provided on the bracket bottom plate 53, a driving shaft 35 connected to the driving part 31, and a main shaft component 360 connected to the driving shaft 35 and the inner rotating cylinder 33.

In an implementation mode, by adopting a layered bracket structure, the bracket top plate, bracket middle plate, and bracket bottom plate are connected to each other through the first bracket column and second bracket column, thereby forming a stable load-bearing frame that can effectively support the outer fixing cylinder and internal rotating component, ensuring the rigidity and coaxially of the overall structure of the motion simulation component in high-pressure environments, and ensuring its structural stability and sealing safety in high-pressure environments. At the same time, arranging the outer fixing cylinder between the bracket top plate and the bracket middle plate ensures even force distribution, which is beneficial for the reliable installation of the sealing structure.

In an implementation mode, the rotating component adopts a bottom driven layout, with the driving part provided on the bracket base plate, connected to the main shaft component through the driving shaft and driving the inner rotating cylinder to rotate, achieving power transmission from bottom to top. The driving component is placed at a lower position of the high-pressure chamber, with strong vibration resistance, and uses the characteristics of fluid static pressure distribution to reduce the pressure difference load on the dynamic seal, providing mechanical support and transmission guarantee for dynamic water flow simulation in high-pressure sealed environment, and improving the stability and safety of the system under high-pressure test conditions.

In an implementation mode, the deep-sea environment simulation test equipment as shown in FIGS. 2 to 5, the outer wall of the outer fixing cylinder 32 is fixed to the first bracket column 541, and the main shaft component 360 includes a main shaft 36, a coupling 34 connected to the driving shaft 35 and the main shaft 36, a first bearing 37 provided on the bracket top plate 51 and connected to the main shaft 36, and a second bearing 38 provided on the bracket middle plate 52 and connected to the main shaft 36. The main shaft 36 passes through the bracket middle plate 52, the outer fixing cylinder 32, the inner rotating cylinder 33, and the bracket top plate 51, respectively.

In an implementation mode, by fixing the outer wall of the outer fixing cylinder to the first bracket column, the outer fixing cylinder has a stable installation position in the high-pressure simulation chamber, which can effectively resist the vibration and displacement generated during the rotation of the inner rotating cylinder, improve the structural stability and concentricity of the entire motion simulation component, ensure the uniformity of the gap between the inner rotating cylinder and the outer fixing cylinder, and thus ensure the stability and controllability of fluid flow in the channel.

In an implementation mode, the outer fixing cylinder can be fixed to the first bracket column through a connecting piece, and the connecting piece can be a fastener such as a screw or a buckle connection.

In an implementation mode, the outer fixing cylinder is fixedly connected to the first bracket column by welding.

In an implementation mode, the main shaft component adopts a main shaft penetrating structure and is connected to the driving shaft through the coupling, allowing the power generated by the driving part to be efficiently and directly transmitted to the inner rotating cylinder, achieving precise rotational control and improving the precision of the motion simulation component in regulating water flow velocity and flow field state.

In an implementation mode, the layout of the main shaft passing through the bracket middle plate, outer fixing cylinder, inner rotating cylinder, and bracket top plate ensures precise assembly positioning of each component, direct power transmission path, and facilitates overall assembly and coaxially calibration, thereby improving equipment assembly efficiency. This arrangement maintains coaxial alignment of the main shaft when passing through the interior of the outer fixing cylinder, providing a stable rotation center for the inner rotating cylinder and ensuring the uniformity of the annular gap between it and the outer fixing cylinder, thereby achieving controllability and stability of the flow field distribution. The overall transmission system has strong load-bearing capacity and stable operation, suitable for long-term and continuous dynamic simulation testing requirements in deep-sea high-pressure environments, improving the reliability and testing accuracy of the equipment.

Besides that, the first bearing and the second bearing are respectively installed on the bracket top plate and bracket middle plate to provide multi-point support and axial positioning for the main shaft, effectively reducing the radial and axial runout of the main shaft during high-speed rotation, enhancing the smoothness and reliability of the main shaft transmission, reducing mechanical wear and vibration noise, and extending the service life of the equipment. In an implementation mode, the first and second bearings are distributed at different height positions on the bracket, ensuring good rigidity and support strength of the main shaft under long stroke, improving the rotational accuracy and anti-bending ability of the main shaft during high-speed rotation, reducing deflection and vibration during operation, facilitating the assembly, debugging, and maintenance of various components, and enhancing the engineering practicality and operational convenience of the overall structure.

In an implementation mode, the main shaft and the inner rotating cylinder can be connected through one or more connection ways such as mortise and tenon connection, snap fit connection, fastener connection, riveting, or welding.

In an implementation mode, the main shaft 36 and the inner rotating cylinder 33 are fixedly connected through keyway or interference fit to ensure power transmission.

In an implementation mode, as shown in FIG. 1, in order to improve the electrical safety and long-term reliable operation of the rotating component 30 in harsh deep-sea simulation environments such as high voltage, high humidity, and strong corrosion, an outer side of the rotating component 30 is connected to a motor housing 9.

In an implementation mode, there are sealing components such as silicone rings, rubber rings, etc. connected between the main shaft and the outer fixing cylinder. The outer fixing cylinder is provided with a channel that communicates with the high-pressure chamber, this channel is far away from the simulated test object to reduce the impact of water flow overflowing around the intended test object on detection accuracy.

In an implementation mode, there is a small amount of water supply space left between the main shaft and the outer fixing cylinder to reduce the collision wear of the main shaft rotation on the outer fixing cylinder.

In an implementation mode, the driving part is a motor, an output shaft of the driving part is vertically upward, fixed at a center of the bracket bottom plate. The outer fixing cylinder is concentric with the inner rotating cylinder, and a diameter of the inner rotating cylinder is slightly smaller than that of the outer fixing cylinder. The main shaft passes through the first bearing, bracket top plate, outer fixing cylinder, inner rotating cylinder, second bearing, and bracket middle plate in sequence from top to bottom. The first bearing is fixed at a center of the bracket top plate, and the second bearing is fixed at a center of the bracket middle plate. The arc-shaped base plate is embedded in a square hole of the outer fixing cylinder, and inner wall surfaces of the two are in contact. The motion simulation test object is attached to the inner wall of the arc-shaped base plate. An output shaft of the driving part drives the main shaft and the inner rotating cylinder to rotate through the coupling, generating a controllable water flow between the outer fixing cylinder and the inner rotating cylinder.

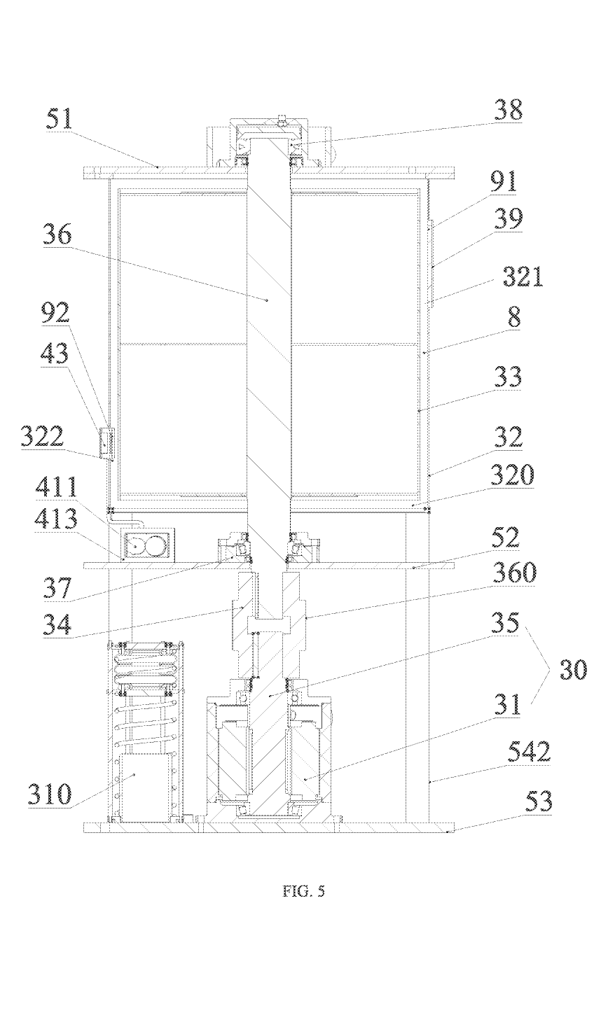

In an implementation mode, as shown in FIGS. 1 and 5, the outer fixing cylinder is fixed to an upper side of the bracket middle plate through a transverse connecting bracket, and there is space between a bottom of the outer fixing cylinder and the bracket middle plate for installing the crack simulation component and the second bearing.

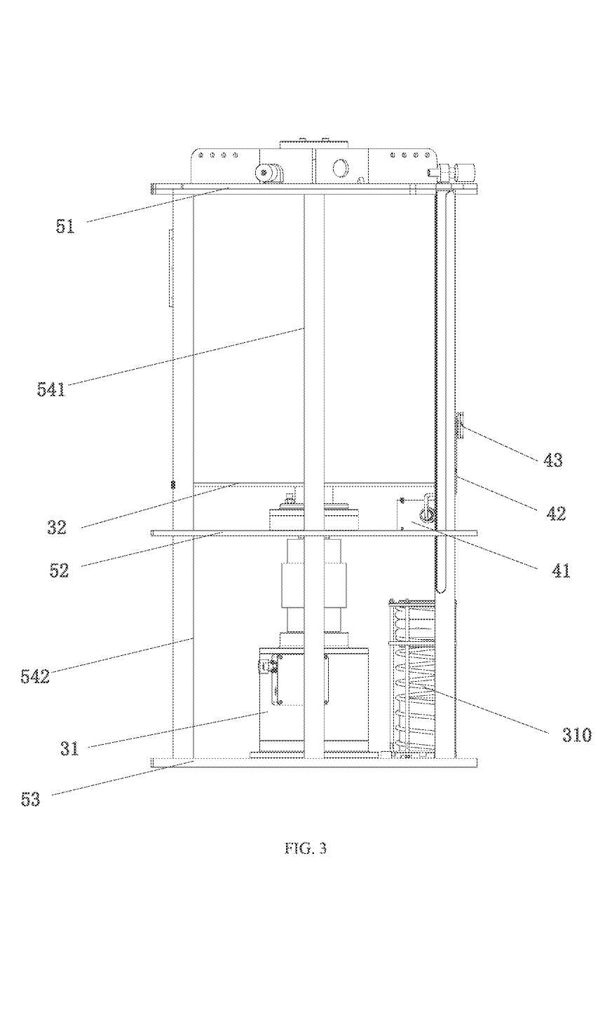

In an implementation mode, the deep-sea environment simulation test equipment as shown in FIGS. 3 to 6, the crack simulation component 4 includes a push rod component 41 fixed to the bracket middle plate 52, a connection rod 42 connected to the push rod component 41, and a clamping component 43 connected to the connection rod 42. The outer wall of the outer fixing cylinder 32 is provided with a second installation hole 322 communicated to th outer fixing cylinder inner cavity 320, and the clamping component 43 is embedded into the second installation hole 322.

In an implementation mode, the crack simulation component of the present disclosure ensures its structural stability and load-bearing capacity inside the high-pressure chamber by fixing the push rod component to the bracket middle plate. The push rod component is connected to the clamping component through a connection rod to achieve force transmission and drive the clamping component to move radially to cause a prefabricated sample to move. The clamping component is embedded in the second installation hole provided on the outer wall of the outer fixing cylinder and connected to the outer fixing cylinder inner cavity, so that the tested sample is partially exposed to the high-pressure environment, which can truly simulate the stress response and crack propagation behavior of materials or structures under deep-sea high-pressure conditions in the presence of prefabricated cracks.

In an implementation mode, the crack simulation component can achieve dynamic loading and in-situ observation of crack initiation and propagation processes while maintaining the overall sealing of the high-pressure chamber. At the same time, the interchangeable design of the clamping components facilitates the installation of samples of different sizes, improving the flexibility and applicability of the test.

In an implementation mode, embedding the clamping component into the second installation hole can reduce the transfer of water flow from the second installation hole to the outside of the outer fixing cylinder in the gap.

In an implementation mode, sealing components such as silicone rings, rubber rings, etc. are connected between the clamping component and the second installation hole.

In an implementation mode, the deep-sea environment simulation test equipment as shown in FIGS. 3 to 6, the push rod component 41 includes a linear travel motor 411, push rods 412 connected to the linear travel motor 411 and the connection rod 42 respectively, a watertight shell 413 connected to an outer side of the linear travel motor 411, the connection rod 42 is provided with a fixed part 421 that cooperates with the outer fixing cylinder 32, and the connection rod 42 is fixed on the outer wall of the outer fixing cylinder 32. The clamping component 43 includes a base plate 431 connected to an inner side of the second installation hole 322, a fixing clamp 433 provided on the base plate 431, a movable clamp 432 connected to the connection rod 42 and configured to move relative to the fixing clamp 433, and a crack simulation test object 92 connected between the movable clamp 432 and the fixing clamp 433.

In an implementation mode, by using the push rod component driven by the linear stroke motor, it is possible to achieve control and stable output of pushing or retracting motion of the push rods. Through the linear motion of the push rods, power is transmitted to the clamping component through the connection rod, and the movable clamping device is driven by the connection rod to produce controllable displacement relative to the fixing clamping device. This applies directional tensile, compressive, or shear forces to the crack simulation test object connected between the two, thereby simulating the generation, propagation, or stress state of cracks in materials or structures, and achieving dynamic simulation of prefabricated cracks of different sizes and shapes.

In an implementation mode, the watertight shell is provided on the outer side of the linear travel motor, which can effectively prevent fluid from the high-pressure chamber body from entering the interior of the motor, ensuring the electrical safety and long-term reliable operation of the push rod component in harsh deep-sea simulation environments such as high pressure, high humidity, and strong corrosion, and improving the overall environmental adaptability and working stability of the system.

In an implementation mode, the connection rod is firmly connected to the outer wall of the outer fixing cylinder through the fixed part, ensuring the rigidity and stability of the force transmission path, ensuring accurate transmission and control of the force state during the crack simulation process, and avoiding inaccurate clamping displacement or uneven force application caused by high-pressure deformation.

In an implementation mode, the clamping component is embedded on the inner side of the second installation hole of the outer fixing cylinder through the base plate. The clamping component adopts a structure that cooperates with a fixing clamping device and a movable clamping device, and is integrated on the base plate inside the second installation hole provided on the outer wall of the outer fixing cylinder, so that the crack simulation test object can be firmly clamped and positioned at the predetermined position inside the outer fixing cylinder inner cavity. The crack simulation test object is directly exposed to the deep-sea simulation environment inside the high-pressure chamber, and the pressure-crack coupling effect under actual working conditions is truly reproduced.

In an implementation mode, by adjusting the movement of the movable clamp relative to the fixing clamp, the loading state and crack morphology of the crack simulation test object can be flexibly changed, such as simulating opening mode crack, sliding mode crack, or tearing mode crack, achieving simulation of different crack types, loading methods, and propagation processes, and enhancing the diversity and engineering representativeness of the test.

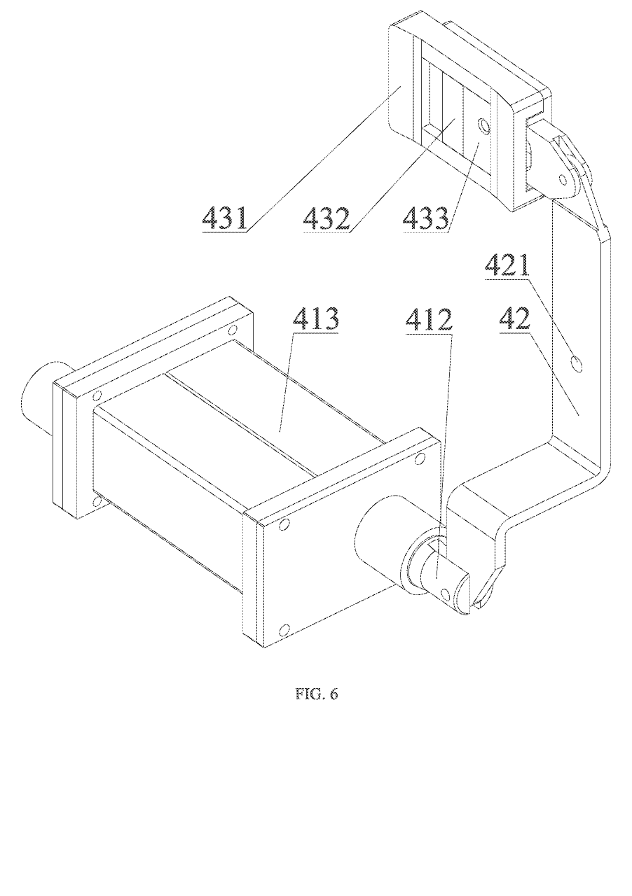

In an implementation mode, the base plate is provided with a base plate opening and a sliding space for the movable clamp to enter, as shown in FIG. 6. The sliding space is provided between the fixing clamp and the inner wall of the base plate. When the movable clamp moves away from the fixing clamp, it can simulate opening mode crack, sliding mode crack, or tearing mode cracks.

In an implementation mode, as shown in FIGS. 3 and 5, the direction in which the base plate is mounted and embedded into the second installation hole is perpendicular to a direction in which the movable clamp slides.

In an implementation mode, the crack simulation test object can be one or a combination of a sensor, a submersible, a resource exploration device, or to-be-tested material.

In an implementation mode, the crack simulation test object is a flexible sensor.

In an implementation mode, the crack simulation test object is a combination of the flexible sensor and the to-be-tested material.

In an implementation mode, one end of the flexible sensor is fixed to the fixing clamp, and the other end is connected to the mobile clamp.

In an implementation mode, there are sealing components such as a silicone ring, a rubber ring, etc. connected between the mobile clamp and the base plate opening.

In an implementation mode, the base plate opening is provided with a connection hole for an electrical connection between the crack simulation control module, the acquisition component, and the crack simulation test object.

In an implementation mode, as shown in FIG. 6, the fixing clamp is provided with a connection hole for an electrical connection between the crack simulation control module, the acquisition component, and the crack simulation test object.

In an implementation mode, the fixed part is a connection hole for screws to pass through, and the outer fixing cylinder is provided with an adapted outer fixing cylinder connection hole.

In an implementation mode, the fixed part is a connection column, and the outer fixing cylinder is provided with an adapted outer fixing cylinder connection hole.

In an implementation mode, one end of the crack simulation test object is fixed to the movable clamp 432, and the other end is connected to the fixing clamp 433. The linear travel motor 411 drives the push rods 412 to extend forward, the connection rod 42 is driven to rotate around a central fixed point. A lower end of the connection rod 42 moves forward, and an upper end drives the movable clamp 432 to move away from the fixing clamp 433. By controlling the linear travel motor 411 to extend, a prefabricated crack with controllable size is generated. Conversely, by controlling the linear travel motor 411 to retract, the movable clamp 432 returns to its initial position. Multiple crack simulation tests can be conducted under different pressure environments within a bearing range of the crack simulation test object.

In an implementation mode, the deep-sea environment simulation test equipment as shown in FIGS. 3 to 6, a lower end of the connection rod 42 is connected to the push rods 412, a middle of the connection rod 42 is connected to the outer wall of the outer fixing cylinder 32 through the fixed part 421, and an upper end of the connection rod 42 is connected to the movable clamp 432. In an initial position, the movable clamp 432 is in contact with the fixing clamp 433. When the linear travel motor 411 runs, a movement direction of the upper end of the connection rod 42 is opposite to that of the push rods 412.

In an implementation mode, the present disclosure forms a lever type transmission structure with the fixed part as the fulcrum by connecting the lower end of the connection rod to the push rods, hinged or fixed to the outer wall of the outer fixing cylinder through the fixed part in the middle, and connected to the movable clamp at the upper end, so that the linear motion of the push rods can be efficiently and stably converted into the relative displacement of the movable clamp, thereby achieving precise loading control of the crack simulation test object. This layout has a compact structure, which is conducive to reducing the overall structural volume, improving space utilization and assembly convenience. In the initial state, the movable clamp is in contact with the fixing clamp, so that the crack simulation test object can maintain a stable clamping and initial contact state when not loaded, ensuring that the crack simulation test object is in a closed pre tension state, avoiding loosening or eccentric loading, facilitating the installation of the test sample and the setting of the reference state before the test, and providing consistent starting conditions for the subsequent loading process, improving the comparability and reliability of the test data.

In an implementation mode, when the linear travel motor is running, its output end pushes the push rods forward. Due to the constraint of the fixed part in the middle of the connection rod, a lever motion is formed with the fixed part as the fulcrum, causing the upper end of the connection rod to produce a displacement opposite to the movement direction of the push rods, thereby driving the movable clamp to move backward away from the fixing clamp, achieving control of the opening or closing of the crack simulation test object. In a limited space, a shorter stroke of the push rods can be converted into a larger range of relative displacement of the movable clamp, effectively expanding the loading stroke and action range without increasing the overall structural size, and improving the flexibility and applicability of the crack simulation test. In addition, the reverse motion relationship combined with the fixed fulcrum design of the connection rod helps to achieve directional force transmission and stable control, enabling the mobile clamp to apply controllable tensile, compressive, or shear forces to the crack simulation test object along the preset direction, simulating the stress state and propagation process of different types of cracks, and enhancing the pertinence and engineering practicality of the test.

In an implementation mode, the deep-sea environment simulation test equipment as shown in FIG. 1, the motion simulation component 3 includes a compensator 310 provided on the bracket bottom plate 53, the high-pressure chamber body 2 is provided with a high-pressure chamber body 2 for the simulation device 300 to enter, and an end cover 21 covering an opening of the high-pressure chamber 20. The measurement and control device 200 is connected to a data port of the end cover 21.

In an implementation mode, the motion simulation component of the present disclosure is provided with the compensator on the bracket bottom plate, which can dynamically absorb or release medium inside the high-pressure chamber when the fluid volume fluctuates due to the rotation of the inner rotating cylinder or changes in system temperature, effectively suppressing pressure fluctuations caused by the operation of moving parts, maintaining the stability of the high-pressure simulation environment, and overcoming the technical problem of rapid pressure fluctuations easily caused by dynamic simulation in closed high-pressure vessels.

In an implementation mode, the high-pressure chamber is provided with the high-pressure chamber body for accommodating the simulation device, and its opening is sealed with the end cover to ensure the pressure bearing reliability and sealing performance of the overall structure, enhance the structural compactness and sealing safety of the overall equipment, and help maintain pressure stability inside the high-pressure chamber body, improving the authenticity of deep-sea environment simulation and the accuracy of experimental data. The measurement and control device establishes electrical connections with various sensors and actuators in the chamber through the data port on the end cover, achieving safe and stable signal transmission in high-pressure environments. This not only facilitates the installation and maintenance of the simulation device, but also ensures real-time acquisition and closed-loop control of key parameters such as water flow velocity, crack state, pressure, temperature, etc. during a test process, improving the safety, controllability, and test accuracy of the entire machine under deep-sea high-pressure dynamic simulation conditions.

In an implementation mode, the deep-sea environment simulation test equipment as shown in FIG. 1, the acquisition component 7 includes a clock synchronization module 71, a multi-channel signal conditioning module 72, and an acquisition module 73. The clock synchronization module 71 is configured to convert a single clock signal into multiple synchronized clocks to ensure the time consistency of parameter sampling in each channel of the acquisition module 73. The multi-channel signal conditioning module 72 is configured for preprocessing data in each channel. The acquisition module 73 is configured to collect pressure environment parameters and temperature environment parameters of the high-pressure chamber body 2, water flow velocity parameters of the motion simulation component 3, crack size parameters of the crack simulation component 4, and state parameters of the test object.

In an implementation mode, in the present disclosure, by providing the clock synchronization module, a single clock signal can be converted into multiple synchronized clock signals, providing a unified time reference for multiple data acquisition channels in the acquisition system, ensuring strict synchronization of data in the time dimension, effectively avoiding sampling deviation and data distortion caused by clock asynchrony, improving the time consistency and data reliability of multi parameter synchronous acquisition, and providing accurate timing basis for subsequent correlation analysis and comprehensive evaluation of experimental data.

In an implementation mode, the multi-channel signal conditioning module can filter, amplify, isolate, linearize and other pre-processing of multi type and multi range signals from different sensors, improve the signal to noise ratio and stability of signals, ensure that various parameter signals have good quality before being transmitted to the acquisition module, enhance the adaptability of the acquisition system to complex signal environments, protect the back-end acquisition circuit from interference and damage, and improve the overall signal acquisition quality and operation safety of the system.

In an implementation mode, the acquisition module is capable of comprehensively collecting pressure and temperature environmental parameters inside the high-pressure chamber, as well as water flow velocity parameters related to the motion simulation component, crack size parameters related to the crack simulation component, and state parameters of the test object. This enables centralized monitoring and data acquisition of multiple physical fields, objects, and dimensions in deep-sea simulation experiments, providing detailed and accurate data support for the comprehensive evaluation of the performance, structural response, and safety state of the to-be-test object in complex dynamic environments.

In an implementation mode, through the collaborative work of the above modules, the present disclosure achieves high-precision, multi-channel, and synchronized collection of key environmental parameters and experimental parameters during deep-sea environment simulation experiments, ensuring the integrity, consistency, and traceability of experimental data, thereby improving the monitoring capability, analysis depth, and experimental effectiveness of the experimental process.

An embodiment of the present disclosure further provides a control method for deep-sea environment simulation test equipment, including the deep-sea environment simulation test equipment, motion simulation test object 91, and crack simulation test object 92 as described above, and the method includes the following steps:

S1: installing the motion simulation test object 91 and crack simulation test object 92 onto the motion simulation component 3 and crack simulation component 4, respectively;

S2: after sealing the simulation device 300 in the high-pressure chamber body 2, connecting the measurement and control device 200 to the high-pressure chamber body 2;

S3: starting the high-pressure pump station 1, increasing pressure inside the high-pressure chamber body 2 to a required simulated test water pressure; performing pressurization and depressurization processes in stages, and conducting simulation tests at different pressure levels to observe and recording state parameters of the to-be-test object at different pressures, pressurization processes, and depressurization processes through the acquisition component 7; high-pressure fluid generated by the high-pressure pump station is transported to a sealed high-pressure chamber body through a high-pressure pipeline, thereby simulating the required deep-sea high-pressure environment inside the chamber body.

In an implementation mode, when conducting deep-sea environment simulation experiments, the first step is to confirm that the motion simulation test object and the crack simulation test object are installed in place. Then use a waterproof cable to connect the simulation device to a waterproof interface of the end cover of the high-pressure chamber body. After the end cover is installed in place and sealed, the multi parameter measurement and control device are connected to the end cover; turn on the power, check if the power voltage and data link are normal, and after all modules complete self-inspection, turn on the high-pressure pump station to increase the pressure inside the high-pressure chamber to the required simulated test water pressure. The pressurization and depressurization processes can be carried out in stages, and simulation tests can be conducted at different pressure levels to observe the state parameters of the test object under different pressures, pressurization processes, and depressurization processes.

In an implementation mode, by installing the motion simulation test object and the crack simulation test object separately on the corresponding motion simulation component and crack simulation component, synchronous or independent simulation of the deep sea dynamic water flow environment and structural crack defect environment is achieved, enabling the test object to undergo assessment under composite conditions that are closer to real service conditions, improving the pertinence and engineering practicality of the test.

In an implementation mode, the simulation device is placed in the high-pressure chamber body and sealed before connecting to the measurement and control device, ensuring the structural integrity, sealing safety, and system controllability under high-pressure environment. This provides a reliable physical basis and control interface for conducting simulation tests under high-pressure conditions, ensuring the safety, stability, and operability of the test process. By starting the high-pressure pump station to increase the pressure inside the high-pressure chamber body to the required simulated water pressure, and supporting stage control of the pressurization and depressurization processes, the experiment can be carried out in stages at different pressure levels, which is conducive to gradually investigating the structural response, performance changes, and failure modes of the test object in different stages such as pressure rise, high-pressure maintenance, and pressure drop. It can more realistically simulate the complex pressure environment that deep-sea equipment may experience in practical operations, and improve the comprehensiveness and scientific of the experiment.

In an implementation mode, by collecting real-time state parameters of the test object through components during different pressures and pressure changes, multi parameter, multi-stage, high-precision test data can be obtained, providing detailed basis for analyzing the mechanical behavior, sealing performance, structural integrity, and functional reliability of the test object under high pressure and dynamic pressure conditions, thereby improving the effectiveness, traceability, and analysis depth of the test data.

The present disclosure has a simple structure and reliable function. The designed motion simulation component generates controllable water flow by adjusting the motor speed, and restricts the water flow between the outer fixing cylinder and the inner rotating cylinder, which can reduce the impact of water flow on the pressure inside the high-pressure chamber body. The designed crack simulation component can not only control the crack simulation component to generate controllable sized cracks under static high pressure, but also simulate cracks under dynamically adjustable water flow, combining dynamic and static crack simulation testing functions. The designed multi parameter measurement and control device can avoid signal distortion and data errors caused by asynchrony.

The above embodiments are only used to further illustrate the technical content of the present disclosure for the convenience of readers to understand more easily, but it does not mean that the embodiments of the present disclosure are limited to this. Any technical extension or recreation made in accordance with the present disclosure is protected by the present disclosure. The protection scope of the present disclosure shall be subject to the claims.

What is claimed is:

1. A deep-sea environment simulation test equipment, comprising: a high-pressure simulation chamber and a measurement and control device,
wherein the high-pressure simulation chamber comprises a high-pressure pump station and a high-pressure chamber body configured to simulate deep-sea high-pressure environment, high-pressure fluid generated by the high-pressure pump station is transported to the sealed high-pressure chamber body through a high-pressure pipeline,
the high-pressure chamber body is provided with a simulation device, the simulation device comprises a motion simulation component and a crack simulation component,
wherein the motion simulation component is configured to generate controllable water flow by rotation, the crack simulation component is configured to generate prefabricated cracks of different sizes, and the measurement and control device comprises a control component and an acquisition component,
the control component comprises an industrial computer and a water flow simulation control module electrically connected to the motion simulation component, a crack simulation control module electrically connected to the crack simulation component, and the acquisition component is configured to record parameters inside the high-pressure chamber body and state parameters of a to-be-test object;
wherein the motion simulation component comprises a bracket, an outer fixing cylinder connected to the bracket, an inner rotating cylinder provided inside the outer fixing cylinder, a rotating component connected to the inner rotating cylinder, a gap provided between an inner wall of the outer fixing cylinder and an outer wall of the inner rotating cylinder,
the outer fixing cylinder is provided with the outer fixing cylinder inner cavity, an outer wall of the outer fixing cylinder is provided with a first installation hole communicated to the outer fixing cylinder inner cavity, and an arc-shaped base plate connected to the first installation hole;
an inner wall of the arc-shaped base plate is connected to a motion simulation test object.

2. The deep-sea environment simulation test equipment according to claim 1, wherein the bracket comprises a bracket top plate, a bracket middle plate, a bracket bottom plate, a first bracket column connected between the bracket top plate and the bracket middle plate, a second bracket column connected between the bracket middle plate and the bracket bottom plate,
the outer fixing cylinder is provided between the bracket top plate and the bracket middle plate,
the rotating component comprises a driving part provided on the bracket bottom plate, a driving shaft connected to the driving part, and a main shaft component that is connected to the driving shaft and the inner rotating cylinder.

3. The deep-sea environment simulation test equipment according to claim 2, wherein the outer wall of the outer fixing cylinder is fixed to the first bracket column, and the main shaft component comprises a main shaft, a coupling connected to the driving shaft and the main shaft, a first bearing provided on the bracket top plate and connected to the main shaft, and a second bearing provided on the bracket middle plate and connected to the main shaft,
wherein the main shaft passes through the bracket middle plate, the outer fixing cylinder, the inner rotating cylinder, and the bracket top plate.

4. The deep-sea environment simulation test equipment according to claim 2, wherein the crack simulation component comprises a push rod component fixed to the bracket middle plate, a connection rod connected to the push rod component, and a clamping component connected to the connection rod,
the outer wall of the outer fixing cylinder is provided with a second installation hole communicated to the outer fixing cylinder inner cavity, and the clamping component is embedded into the second installation hole.

5. The deep-sea environment simulation test equipment according to claim 4, wherein the push rod component comprises a linear travel motor, push rods respectively connected to the linear travel motor and the connection rod, a watertight shell connected to an outer side of the linear travel motor,
the connection rod is provided with a fixed part that cooperates with the outer fixing cylinder, the connection rod is fixed to the outer wall of the outer fixing cylinder, and the clamping component comprises a base plate connected to an inner side of the second installation hole, a fixing clamp provided on the base plate, and a movable clamp that is connected to the connection rod and is configured to move relative to fixing clamp;
wherein a crack simulation test object is connected between the movable clamp and the fixing clamp.

6. The deep-sea environment simulation test equipment according to claim 5, wherein a lower end of the connection rod is connected to the push rods, a middle of the connection rod is connected to the outer wall of the outer fixing cylinder through a fixed part, and an upper end of the connection rod is connected to the movable clamp;
in an initial position, the movable clamp is in contact with the fixing clamp, when the linear travel motor runs, a movement direction of the upper end of the connection rod is opposite to that of the push rods.

7. The deep-sea environment simulation test equipment according to claim 2, wherein the motion simulation component comprises a compensator provided on the bracket bottom plate,
the high-pressure chamber body is provided with a high-pressure chamber for the simulation device to extend into, and an end cover covering an opening of the high-pressure chamber,
wherein the measurement and control device is connected to a data port of the end cover.

8. The deep-sea environment simulation test equipment according to claim 1, wherein the acquisition component comprises a clock synchronization module, a multi-channel signal conditioning module, and an acquisition module,
the clock synchronization module is configured to convert a single clock signal into multiple synchronized clocks,
the multi-channel signal conditioning module is used for preprocessing data of each channel, and
the acquisition module is configured to collect pressure environment parameters and temperature environment parameters of the high-pressure chamber body, water flow velocity parameters of the motion simulation component, crack size parameters of the crack simulation component, and state parameters of the to-be-test object.

9. A control method for deep-sea environment simulation test equipment, wherein it comprises the deep-sea environment simulation test equipment, the motion simulation test object, and a crack simulation test object according to claim 1, and the control method comprises the following steps:
S1: installing the motion simulation test object and crack simulation test object onto the motion simulation component and crack simulation component, respectively;
S2: after sealing the simulation device in the high-pressure chamber body, connecting the measurement and control device to the high-pressure chamber body;
S3: starting the high-pressure pump station, increasing pressure inside the high-pressure chamber body to a required simulated test water pressure; performing pressurization and depressurization processes in sections, and conducting simulation tests at different pressure levels to observe and recording state parameters of the to-be-test object at different pressures, pressurization processes, and depressurization processes through the acquisition component.
